(19) United States
(12) Patent Application Publication
(10) Pub. No.: US 2026/0122757 A1
(43) Pub. Date: Apr. 30, 2026

(54) TESLA VALVE PROTECTION OF ACCELERATOR COMPONENTS

(71) Applicant: FERMI FORWARD DISCOVERY GROUP, LLC, Chicago, IL (US)

(72) Inventor: Thomas Kroc, Batavia, IL (US)

(21) Appl. No.: 19/175,522

(22) Filed: Apr. 10, 2025

Related U.S. Application Data
(60) Provisional application No. 63/634,303, filed on Apr. 15, 2024.

(51) Int. Cl. H05H 7/14; H05H 6/00; H05H 7/00; H05H 7/04

(52) U.S. Cl. CPC H05H 7/14; H05H 6/00; H05H 7/001; H05H 7/04; H05H 2006/002; H05H 2007/002; H05H 2007/048

(57) ABSTRACT

A vacuum protection apparatus comprises a main line conduit and at least one recirculating side chamber comprising a tesla valve, the recirculating side chamber further including a side chamber conduit, an inlet to the side chamber conduit, a curve in the side chamber conduit, and an outlet connected to the main line conduit.

### CROSS REFERENCE TO RELATED PATENT APPLICATIONS

This application claims the priority and benefit under 35 U.S.C. § 119 (e) of U.S. Provisional Patent Application Ser. No. 63/634,303 filed Apr. 15, 2024, entitled “TESLA VALVE PROTECTION OF ACCELRATOR COMPONENTS”. U.S. Provisional Patent Application Ser. No. 63/634,303 is herein incorporated by reference in its entirety.

### STATEMENT OF GOVERNMENT RIGHTS

The invention described in this patent application was made with Government support under the Fermi Research Alliance, LLC, Contract Number DE-ACO2-07CH11359 awarded by the U.S. Department of Energy. The Government has certain rights in the invention.

### TECHNICAL FIELD

Embodiments are generally related to the field of particle accelerators. Embodiments further relate to magnetic devices and accelerators that produce electron beams and/or Bremsstrahlung X-rays. Embodiments are also related to systems and methods for protecting accelerator components in the event of vacuum window failure.

### BACKGROUND

Irradiation is a process by which an object may be exposed to radiation. The exposure can originate from various sources, including natural sources or engineered systems. Irradiation can be used for applications such as sterilization, medical applications, ion implantation, ion irradiation, and industrial chemical applications. Irradiation can use an electron beam itself, or by way of a Bremsstrahlung converter, X-rays. X-rays may be produced by irradiating a target made of a material containing a large proportion of high atomic number atoms or ions with a suitably high-energy electron beam by accelerating electrons across a large potential difference creating a beam of high-energy electrons and then guiding the beam to the target can produce the X-ray beam. The electrons in the electron beam interact with the electric field of the high atomic number nuclei and emit X-ray photons through the Bremsstrahlung process. The X-rays have a continuous spectrum, having an upper energy limit determined by the energy of the incident electrons.

In order to use electron beams or X-rays for industrial sterilization and other irradiation processes, the electron beam may be spread out into a curtain or a sheet. This can be accomplished with a scanning magnet used to sweep the electron beam back and forth to create the curtain or sheet to irradiate an item or to produce X-rays to then irradiate an item. The electrons or subsequent X-rays may remain divergent. In some cases, however, it may be more efficient and more useful in irradiation applications if the electron beam is redirected, using another magnet, to a trajectory that is parallel, but displaced from the original electron trajectory. This parallelized electron beam can then be used to either irradiate an item or to create X-rays to perform the irradiation.

Systems and methods used for scanning particle beams require a high vacuum assembly. In many applications, the vacuum of the accelerating system is separated from the ambient atmosphere, where the particle beam is applied, by a vacuum window. If the window breaks, the atmosphere and window debris rush into the vacuum chamber at supersonic speeds before prior art protection systems, can respond. In the case where the vacuum window fails, the resulting debris and pressure wave can cause catastrophic damage to the associated accelerator components. As such, there is a need in the art for methods and systems for protecting accelerators components in the event of damage to the vacuum assembly.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a magnetic apparatus for use in irradiation processes with an integrated vacuum safety assembly.

It is another aspect of the disclosed embodiments to integrate a tesla shaped valve with other safety components to reduce the damage caused by vacuum window failure.

It is another aspect of the disclosed embodiments to slow the progress of the shock wave and debris, reducing the length of beam line necessary for protection systems to respond.

The aforementioned aspects and other objectives and advantages can now be achieved as described herein. In an embodiment, an apparatus, comprises a main line conduit and at least one recirculating side chamber comprising: a side chamber conduit, an inlet to the side chamber conduit, a curve in the side chamber conduit, and an outlet connected to the main line conduit. In an embodiment, the airflow exiting the outlet intersects airflow in the main line conduit. In an embodiment, the at least one recirculating side chamber comprises a plurality of recirculating side chambers arranged in line along the main line conduit. In an embodiment, the plurality of recirculating side chambers arranged symmetrically along the main line conduit. In an embodiment, the plurality of recirculating side chambers arranged asymmetrically along the main line conduit. In an embodiment, the main line conduit is configured to transport a particle beam. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

In another embodiment, an apparatus, comprises a main line conduit and at least one pressure directing side chamber comprising: a side chamber conduit, an inlet connected to a side chamber conduit, a curve in the side chamber conduit, and a manifold connected to the side chamber conduit. In an embodiment, the apparatus further comprises a pressure vessel attached to the manifold. In an embodiment, the side chamber conduit angles away from the main line conduit. In an embodiment, the at least one pressure directing side chamber comprises a plurality of pressure directing side chambers arranged in line along the main line conduit. In an embodiment, the main line conduit is configured to transport a particle beam. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

In another embodiment an apparatus, comprises a main line conduit, at least one recirculating side chamber comprising: a side chamber conduit, an inlet to the side chamber conduit, a curve in the side chamber conduit, and an outlet connected to the main line conduit, and at least one pressure directing side chamber comprising: a side chamber conduit, an inlet connected to a side chamber conduit, a curve in the side chamber conduit, and a manifold connected to the side chamber conduit. In an embodiment, the apparatus further comprises a pressure vessel attached to the manifold. In an embodiment, airflow exiting the outlet intersects airflow in the main line conduit. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

### BRIEF DESCRIPTION OF THE FIGURES

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 depicts a perspective cut-away view of RF structures that can form elements of an electron accelerator that can be adapted for use in accordance with disclosed embodiments;

FIG. 2A depicts a perspective cut-away view of a superconducting RF structure that can also form elements of an electron accelerator adapted for use in accordance with an embodiment. The figure indicates the operating principles of such an elliptical RF cavity;

FIG. 2B depicts an accelerator system, in accordance with the disclosed embodiments;

FIG. 3 illustrates a schematic diagram of a magnetic apparatus, in accordance with the disclosed embodiments;

FIG. 4A illustrates a schematic diagram of a scan horn protector assembly, in accordance with the disclosed embodiments;

FIG. 4B illustrates the functional mechanisms associated with the scan horn protector, in accordance with the disclosed embodiments;

FIG. 4C illustrates a shape of a scan horn protector, in accordance with the disclosed embodiments;

FIG. 5 illustrates a tesla valve assembly, in accordance with the disclosed embodiments;

FIG. 6 illustrates a pressure vessel assembly, in accordance with the disclosed embodiments;

FIG. 7A illustrates beam focusing in association with a tesla valve assembly, in accordance with the disclosed embodiments;

FIG. 7B illustrates another view of beam focusing in association with a tesla valve assembly, in accordance with the disclosed embodiments;

FIG. 8 illustrates a system incorporating a tesla valve and pressure vessel assembly, in accordance with the disclosed embodiments; and

FIG. 9 illustrates a scan horn protector and tesla valve assembly, in accordance with the disclosed embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

Unless defined otherwise, all technical and scientific terms used herein have the same meanings as commonly understood by one of ordinary skill in the art. As used in this document, the term “comprising” means “including, but not limited to.” The term “at least one” conveys “one or more”.

U.S. Pat. No. 10,070,509, titled “COMPACT SRF BASED ACCELERATOR,” issued on Sep. 4, 2018, describes a particle accelerator comprising an accelerator cavity, an electron gun, and a cavity cooler configured to at least partially encircle the accelerator cavity. A cooling connector and an intermediate conduction layer are formed between the cavity cooler and the accelerator cavity to facilitate thermal conductivity between the cavity cooler and the accelerator cavity. The embodiments disclosed therein teach a viable, compact, robust, high-power, high-energy electron-beam, or x-ray source. The disclosed advances are integrated into a single design, that enables compact, mobile, high-power electron accelerators. U.S. Pat. No. 10,070,509 is herein incorporated by reference in its entirety.

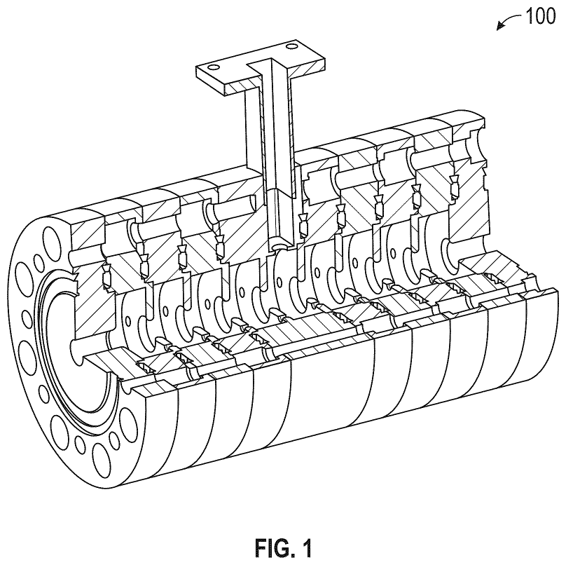

FIG. 1 illustrates a perspective cut-away view of an RF structure 100 that can form elements of an electron accelerator that can be adapted for use in accordance with embodiments disclosed herein. Note that RF accelerator and electron gun structures can be employed to produce electron beams of the required energy for implementation of the disclosed embodiments. An electron accelerator, for example, that employs the RF structure 100 can accelerate electrons generated from an electron gun with RF electric fields in resonant cavities sequenced such that the electrons are accelerated due to an electric field present in each cavity as the electron traverses the cavity.

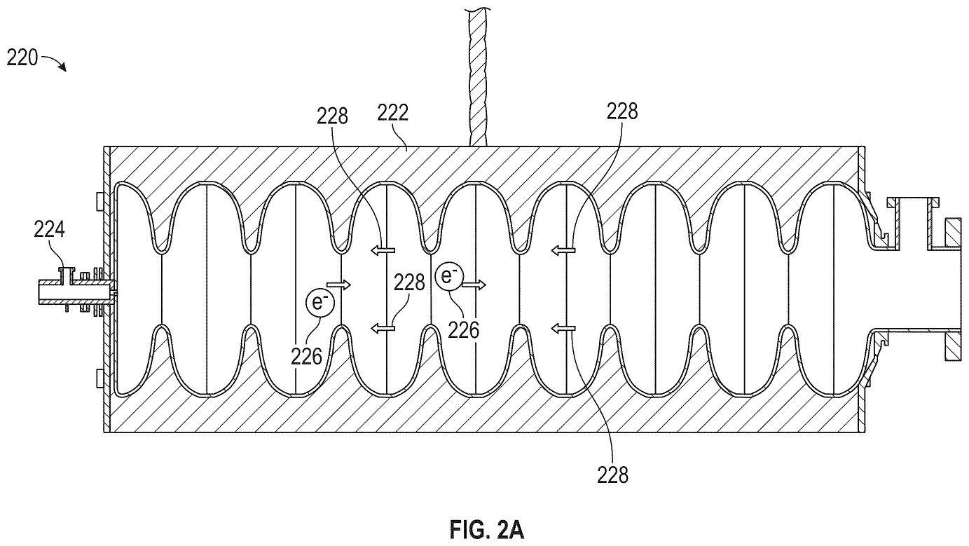

FIG. 2A illustrates a perspective cut-away view of an exemplary 8.5 cell elliptical superconducting RF structure 220 that can also form elements of an electron accelerator adapted for use in accordance with the disclosed embodiments. Note that varying embodiments can employ alternative cavity geometries and/or cell numbers. FIG. 2A generally indicates the operating principles of an elliptical RF cavity. Advancements in SRF technology can enable even more compact and efficient accelerators for associated applications.

The RF structure 220 of FIG. 2A demonstrates the principle of operation in which alternating RF electric fields can be configured to accelerate groups of electrons timed to arrive in each cavity when the electric field in that cavity causes the electrons to gain additional energy. In the particular embodiment shown in FIG. 2A, a voltage generator can induce an electric field within the RF cavity. Its voltage can oscillate, for example, with a radio frequency of 1.3 Gigahertz or 1.3 billion times per second. An electron source 224 can inject particles into the cavity in phase with the variable voltage provided by the voltage generator of the RF structure 220. Arrow(s) 226 shown in FIG. 2A indicate that the electron injection and cavity RF phase is adjusted such that electrons experience or “feel” an average force that accelerates them in the forward direction, while arrow(s) 228 indicate that electrons are not present in a cavity cell when the force is in the backwards direction. The structure 220 can be cooled with a conduction cooling system 222.

It can be appreciated that the example RF structures 100 and 220, respectively shown in FIGS. 1 and 2A, represent examples only and that electron accelerators of other types and configurations/structures/frequencies may be implemented in accordance with alternative embodiments. That is, the disclosed embodiments are not limited structurally to the example electron accelerator structures 100, 220, respectively shown in FIGS. 1 and 2, but represent one possible type of structure that may be employed with particular embodiments. Alternative embodiments may vary in structure, arrangement, frequency, and type of accelerators, RF structures, and so forth.

In certain embodiments, a coupler feeds RF power into the cavity. A vacuum system can be used to evacuate the cavity. In certain embodiments, a cryogenic system, or cryostat, can be used to keep the cavity at very low temperatures. In other embodiments a conducting system can be used to be a cooling system to remove heat generated by the oscillating electric and magnetic fields.

Aspects of such systems are illustrated in FIG. 2B. Specifically, in an embodiment, an accelerator system 250 can include an accelerating cavity 252 with a radio frequency (RF) input 254, and vacuum connection 256. The beam source 258 and beam exit 260 associated with the accelerator cavity (or cavities) 252 provide a respective beam entrance and beam exit through magnetic and thermal shielding layers 262 and a cryostat 264. The cryostat 264 is configured to maintain the temperature of the accelerator system 250 and can be cooled with a cryogenic connection 266.

In order to use X-rays for industrial sterilization and other irradiation processes, an electronic beam from an accelerator as illustrated in FIG. 1, FIG. 2A or 2B, can be used to produce Bremsstrahlung X-rays by directing the electron beam onto a target. U.S. Pat. No. 10,880,984 titled “Permanent Magnet E-Beam/X-Ray Horn” describes such a system. U.S. Pat. No. 10,880,984 is herein incorporated by reference in its entirety. Other such embodiments are detailed in U.S. Pat. No. 11,291,104 titled “Permanent Magnet E-Beam/X-Ray Horn”. U.S. Pat. No. 11,291,104 is herein incorporated by reference in its entirety.

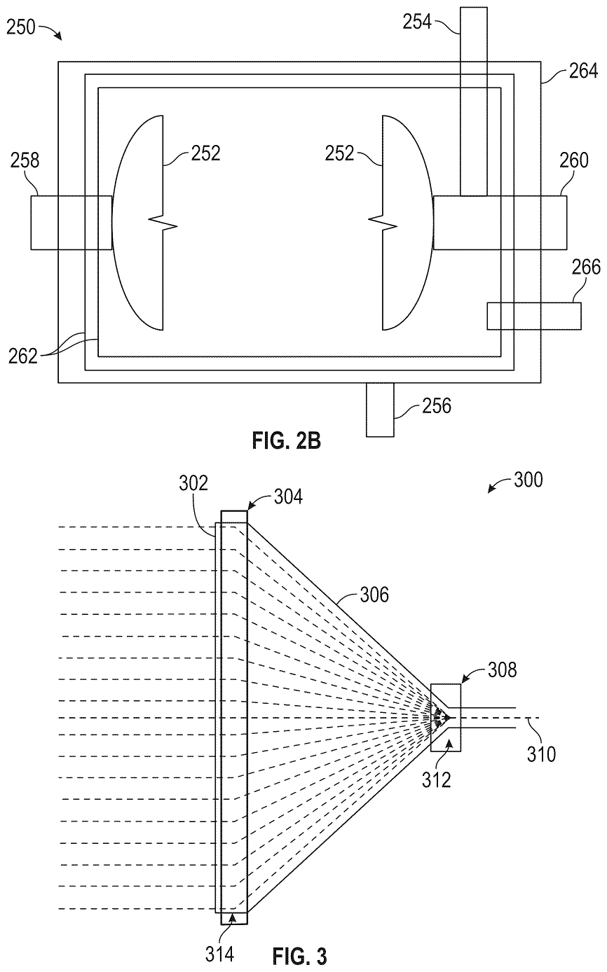

FIG. 3 illustrates a schematic diagram of a magnetic apparatus 300, in accordance with an embodiment. The magnetic apparatus 300 can be used to produce electron beams or X-rays for irradiation processes including, but not limited to, industrial sterilization and other irradiation purposes. The magnetic apparatus 300 can include a scanning electromagnet 308 and a vacuum chamber 306. The vacuum chamber 306 can include a first section 312 and a second section 314. The second section 314 can be wider than the first section 312. Note that in some example embodiments, the vacuum chamber 306 may be a cone-shaped vacuum chamber or a horn-shaped vacuum chamber referred to as a scanning horn vacuum chamber. It should be appreciated, however, that the vacuum chamber 306, although shown as horn-shaped, is not limited to such a shape. Other configurations and shapes are possible. For example, the vacuum chamber 306 can be a rectangular or box-shaped vacuum chamber including a scan horn protection assembly as further detailed herein.

The scanning electromagnet 308 can be utilized to redirect a beam of charged particles. Note that from a physics perspective, there is no physical interaction between the scanning electromagnet 308 and the vacuum chamber 306. The “interaction” is actually between the magnetic field and the charged particles. The vacuum chamber 306 keeps the atmosphere from interfering with the charged particles. The vacuum chamber 306 can be configured from materials that are “transparent” to the magnetic field of the magnets that are external the vacuum chamber 306.

Additionally, it can be appreciated that the disclosed embodiments can be implemented for all charged particles. Electrons, however, are approximately 2000 times lighter than the next lightest particle (protons) so an implementation may be practical for electrons.

A beam line 310 is also depicted in FIG. 3 with respect to the scanning electromagnet 308. A parallelizing permanent magnet array 304 is shown in FIG. 3 with respect to the vacuum chamber 306 at a second section 314 of the vacuum chamber 306, and proximate to a target 302, which may be a Bremsstrahlung target or an object that is being irradiated. Note that in some embodiments, the target 302 can be located in a vacuum window if operating in an electron beam mode. It should be understood that some systems may use more than one vacuum window.

The target 302 can also serve in some example embodiments, as both a vacuum window and a Bremsstrahlung target if operating in an X-ray mode. In still other example embodiments, the vacuum window and Bremsstrahlung target can be separate components. If separate, this allows switching between electron beam and X-ray mode by moving the Bremsstrahlung target out of the way. Note that the parallelizing permanent magnet array 304 can be located within or outside the vacuum chamber 306. In certain embodiments, the Bremsstrahlung target 302 can further include cooling elements, which can be air blowers, water channels, or the like, used to manage the heat at the Bremsstrahlung target 302.

It should be appreciated that the disclosed embodiments are not limited to only an X-ray mode. That is, irradiation can use either the electron beam itself or, by way of a Bremsstrahlung converter, X-rays. Thus, to be clear, the disclosed embodiments are not limited to X-rays. A Bremsstrahlung converter can be located after the permanent magnet if used in X-ray mode.

The parallelizing permanent magnet array 304 can be configured from an array of permanent magnets. Note that the strength of a scanning magnet (in this case the electromagnet 308) should be variable in order to produce all the angles necessary to sweep the beam across the target. Thus, an electromagnet may be used as a scanning magnet, which is the case with the scanning electromagnet 308. The required strength of a parallelizing magnet, however, may be proportional to the position of the electron beam from the beam line 310. For this reason, the parallelizing magnet can be configured from permanent magnet materials that do not require an electric current in the context of the parallelizing permanent magnet array 304. The strength of this permanent magnet material is arranged to provide a magnetic field that increases with distance away from the centerline. This configuration can reduce the operating costs of the magnetic apparatus 300 while facilitating the elimination of failure modes in an irradiation facility.

The magnetic apparatus 300 can produce a spatially varying magnetic field so that the electrons are redirected from a diverging pattern to a parallel pattern. That is, the beam can be redirected by the parallelizing permanent magnet array 304 from a diverging pattern output from the scanning electromagnet 308 to a parallel pattern after being subjected to the parallelizing permanent magnet array 304. In some embodiments, the parallelizing permanent magnet array 304 can be configured as an array of permanent magnets. Note that X-rays are not affected by magnetic fields. They must be generated after the electron beam has been parallelized. In other embodiments, the electrons need not be re-parallelized. That is to say, the systems and method disclosed herein can work without re-parallelizing the electrons before they are converted to X-rays, for example.

The X-ray horn as illustrated in FIG. 3, requires vacuum to operate optimally. Although rare, failure of the window between the vacuum chamber and the ambient environment is catastrophic to the accelerator. Specifically, the release of the vacuum in the event of a breach would introduce debris and extreme pressure, which could be highly damaging to the accelerator. Automatic valves are generally not fast enough to close off the accelerator from the scan horn in the event of a large vacuum failure.

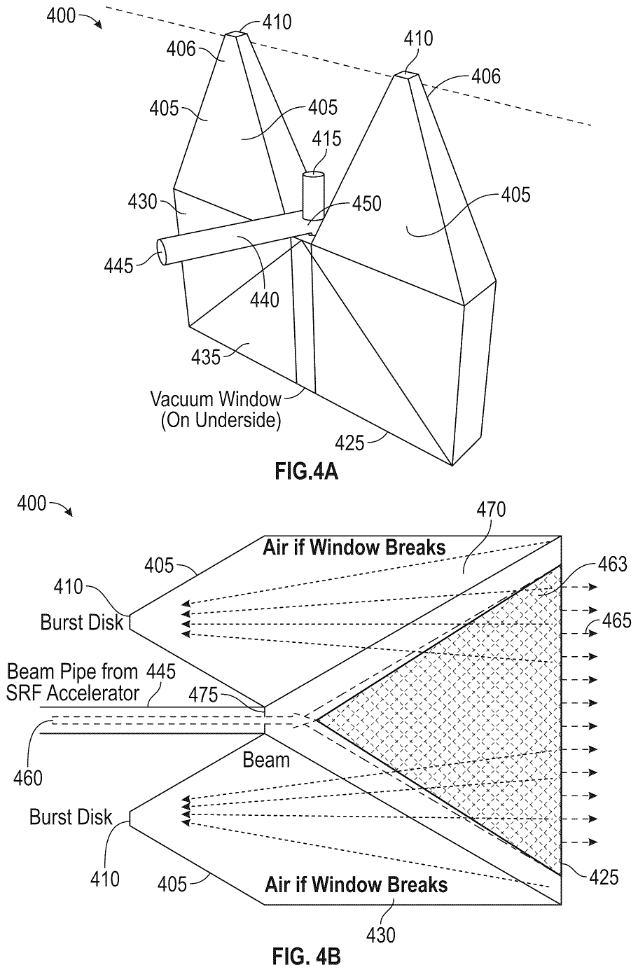

U.S. patent application Ser. No. 18/319,376, titled “ELECTRON BEAM STERILIZATION” illustrates a scan horn protector assembly. In certain embodiments, a scan horn protector assembly 400 as illustrated in FIG. 4A and FIG. 4B, can be used to minimize the impact on the system in case of such a failure. In the event of a vacuum window 425 failure, a shock wave of atmospheric pressure will rush from the point of the rupture to fill the vacuum chamber 430.

Aspects of the scan horn protector assembly 400 include the vacuum chamber housing 435, creating a vacuum chamber 430. The assembly 400 has a proportionally small aperture of the beam port 440 relative to the area of the shock wave. The amount of atmosphere and debris entering the beam port 440 is reduced by this ratio.

Aspects further include shock wave concentrator cones 405, configured as a part of the vacuum chamber housing 435, with sacrificial burst discs 410 at the end 406 of the concentrator cones 405. The shape of the shock wave concentrator cones 405 are configured to direct shock waves away from the fragile aspects of the accelerator assembly. Likewise, the sacrificial burst discs 410 are configured to break in the event of a sudden pressure change, to alleviate the associated pressure reflections that would otherwise be transferred to the fragile aspects of the accelerator assembly.

In addition, the beam pipe 445 can include an angle 450 forming a heavy debris trap 415 to prevent large debris from entering the beam pipe 445. The beam in the beam pipe 445 can be configured to bend with a beam bending magnet. The beam bending magnet can be selected to ensure the beam travels in the beam pipe 445. The beam pipe angle 450 can be selected to be 90 degrees in certain embodiments, although other angles will also suffice for trapping certain debris.

FIG. 4B illustrates the dynamics of the scan horn protector assembly 400 in accordance with the disclosed embodiments. During normal operation, the beam 460 travels through the beam pipe 445 to the scan horn 435 which can allow the beam to expand into expanded beam 463, and travel through the vacuum 430 where it is parallelized as illustrated by beams 465 exiting the window 425.

Because the chamber is under vacuum, if the window 425 breaks, airflow 470 will rush into the volume creating a shockwave. The proportionally small aperture 475 of the beam pipe relative to the area of the shock wave will reduce the impact of the shockwave on the accelerator. Likewise, the sacrificial burst discs 410 at the end of the concentrating cones 405, will break and release pressure, further protecting the accelerator assembly from damage.

FIG. 4C illustrates additional aspects of the scan horn protector assembly 400. In particular, as illustrated in FIG. 4, the shape of the concentrator cones 405 can be selected to have a profile 490 of an off axis parabola with a reflective inner surface. This shape concentrates the inflowing air 495 from the breached vacuum seal, such that the air passes through a relatively large entrance side 480 and through a smaller exit aperture 485. The entrained air flow is focused toward the exit aperture and burst disc 410 formed therein. The disclosed shape of the concentrator cones 405 is carefully selected to ensure that the reflected shock wave forms high pressure on the burst disc 410.

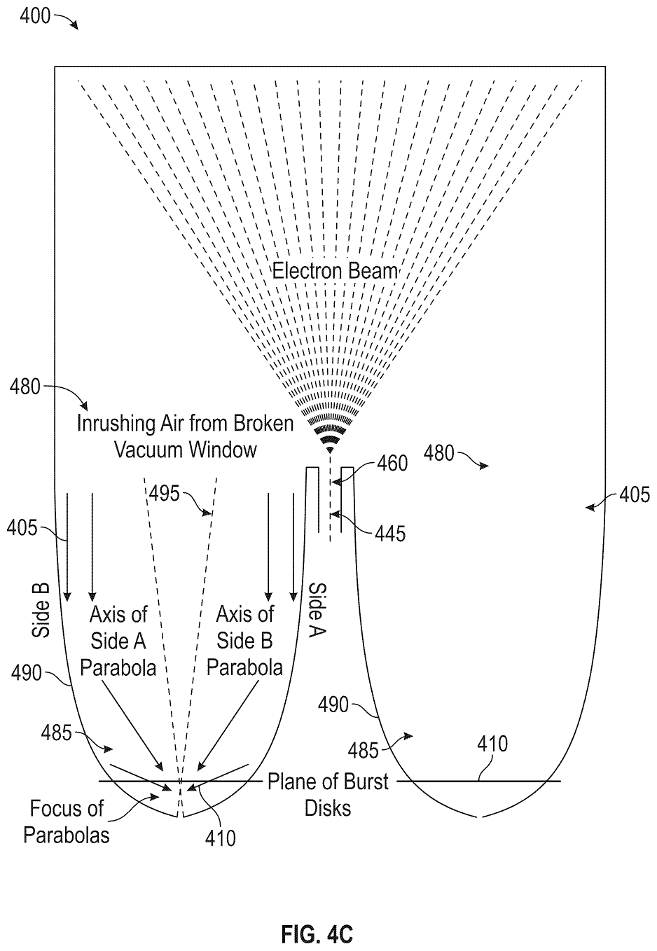

FIG. 5 illustrates a tesla valve 500 in accordance with the disclosed embodiments. The tesla valve 500 can comprise a main line conduit 505 with a series of recirculating side chambers 510. The main line conduit 505 is configured to transport a particle beam 550.

Each of the recirculating side chambers 510 comprises an inlet 515 fluidically connected to a side chamber conduit 520 that angles away from the main line conduit 505. The side chamber conduit 520 further includes a curve 525 such that the side chamber conduit 520 intersects the main line conduit 505 at an outlet 530. The outlet 530 is configured to be down line from the inlet 515.

The angle of the inlet 515 is selected to allow airflow 535 to enter the side chamber conduit 520 as illustrated by airflow 540. The outlet 530 can also be configured at an angle so that the airflow 540 intersects airflow 535 effectively slowing the wave front of the airflow 535.

In certain embodiments, multiple side chamber conduits 520 can be configured on opposing sides of the main line conduit 505. This arrangement allows airflow 535 to be redirected on both sides of the main line conduit.

In addition, multiple side chamber conduits 520 can be configured along the length 545 of the main line conduit 505 with the inlet 515 positioned past the outlet 530 of the preceding side chamber conduit 520 (as viewed along the direction of airflow 535).

In the event of a vacuum failure, the side chamber conduits 520 are configured so that the oncoming atmosphere 535 expands into the side chamber conduits of the tesla valve 500, and is redirected back towards the oncoming wave front 535. This counter pressure slows the wave front 535 and reduces the velocity.

It should be appreciated that the recirculating side chambers 510 are meant to be exemplary and can be configured in other ways. For example, the recirculating side chambers 510 can be annular. In certain embodiments, they can be individual tubes. In certain embodiments they can be positioned along the main line conduit symmetrically, asymmetrically, or to one side only. In certain embodiments, the number of loops can be varied, and the size of the loops can be sized to meet the desired level of impedance and length of the main line conduit. In certain embodiments support elements for the recirculating side chambers can be provided.

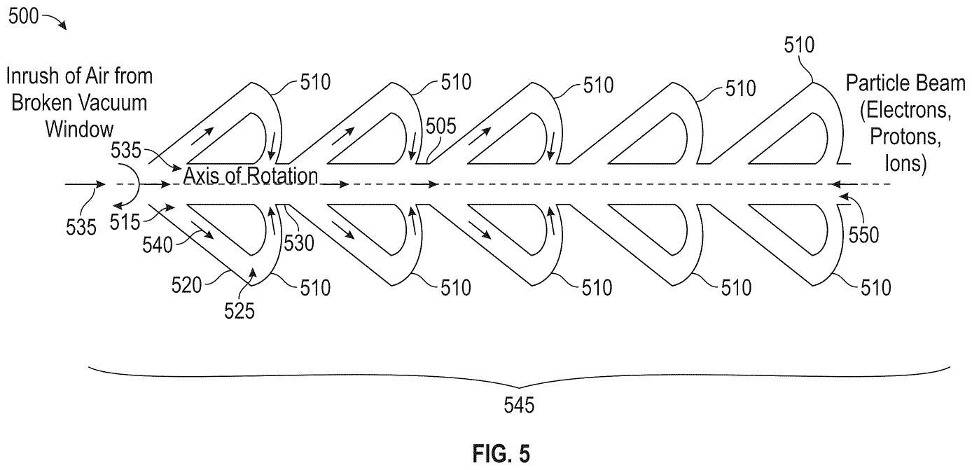

FIG. 6 illustrates an embodiment of a tesla valve and pressure vessel assembly 600 in accordance with the disclosed embodiments. In this embodiment, a main line conduit 605 is fitted with a series of pressure directing side chambers 610. The main line conduit 505 is configured to transport a particle beam 550.

Each of the pressure directing side chambers 610 comprises an inlet 615 fluidically connected to a side chamber conduit 620 that angles away from the main line conduit 605. The side chamber conduit 620 further includes a curve 625 connecting to a manifold 630 in further connection with a large volume pressure vessel 660. The angle of the inlet 615 is selected to allow airflow 635 to enter the side chamber conduit 620 as illustrated by airflow 640. The airflow 640 flows through the side chamber conduit 620 manifold 630 and into the pressure vessel 660.

In certain embodiments, multiple side chamber conduits 620 can be configured on opposing sides of the main line conduit 605. This arrangement allows airflow 635 to be redirected on both sides of the main line conduit 605. In addition, multiple pressure directing side chambers 610 can be configured along the length 645 of the main line conduit 505.

In the event of a vacuum failure, the pressure directing side chambers 610 are configured so that the oncoming atmosphere 635 expands into the side chamber conduits 620 of the tesla valve and pressure vessel assembly 600. The vessel 660 receives much of the incoming gas 635, reducing the amount that proceeds down the beam line of the main line conduit 605. The volume of the vessel(s) 660 can be selected such that they can absorb the inrush of gas flow until separate protection systems, such as fast-acting gate valves, can respond. This embodiment can significantly reduce the amount of gas that reaches the opposite end of the system.

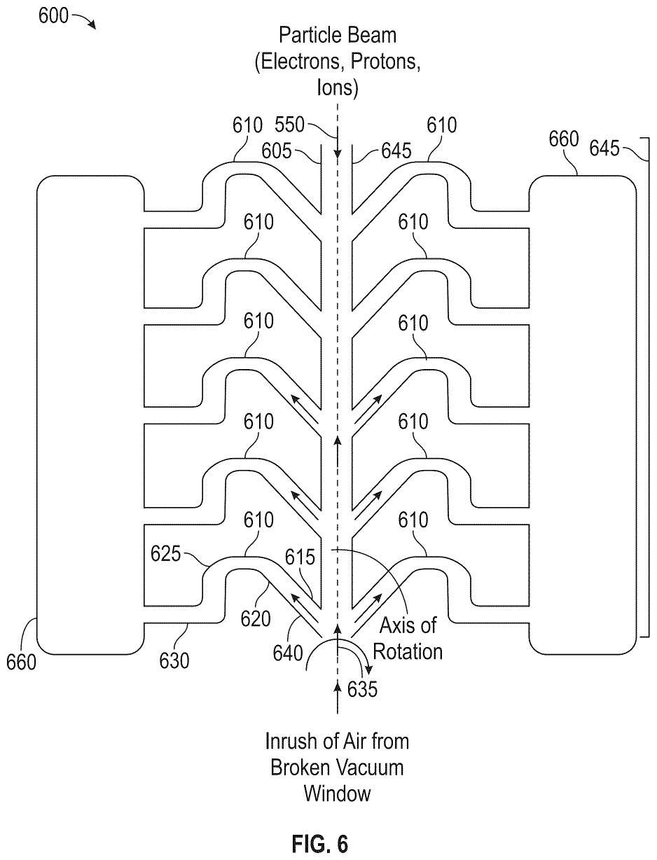

FIGS. 7A and 7B illustrate how beam steering and focusing elements 705 can be incorporated in the system 700 as necessary to maintain desired beam quality. In this embodiment, the recirculating side chambers 510 as shown in FIG. 5, are configured as tubular “handles.” FIG. 7B is shown with a perspective perpendicular to FIG. 7A. Coupled with the effect of the focusing elements 705, which can comprise, for example, quadrupole magnets, the inner profile of the main line conduit 505 can be matched with the profile of the beam 550. The straight-ahead aperture 715 is then narrowed in proportion to the waist of the beam 550 profile. This increases the ratio of the gas that is directed to the side chambers 510 and increases the back pressure at the outlet 530 of the side chambers 510.

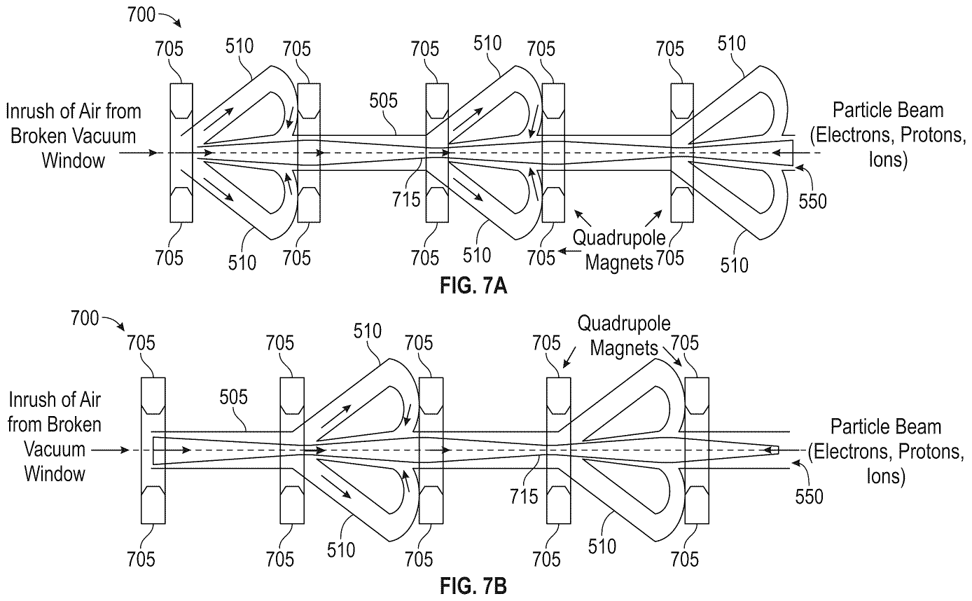

In another embodiment, aspects of the embodiments illustrated above can be combined as illustrated in FIG. 8. In such an embodiment, side chambers 510 of the tesla valve creates a retarding high-pressure area at the confluence of the gas streams 805. Immediately adjacent to this point are inlets 615 fluidically connected to a side chamber conduit 620 that angles away from the main line conduit 505. The side chamber conduit 620 further includes a curve 625 connecting to a manifold 630 in further connection with a large volume pressure vessel 660.

In certain embodiments, the beam focusing elements illustrated in FIG. 5 can be incorporated in the waist at the divergence of the second lobe (with reference to the inrushing gas) which then allows the straight ahead aperture to be reduced at that point.

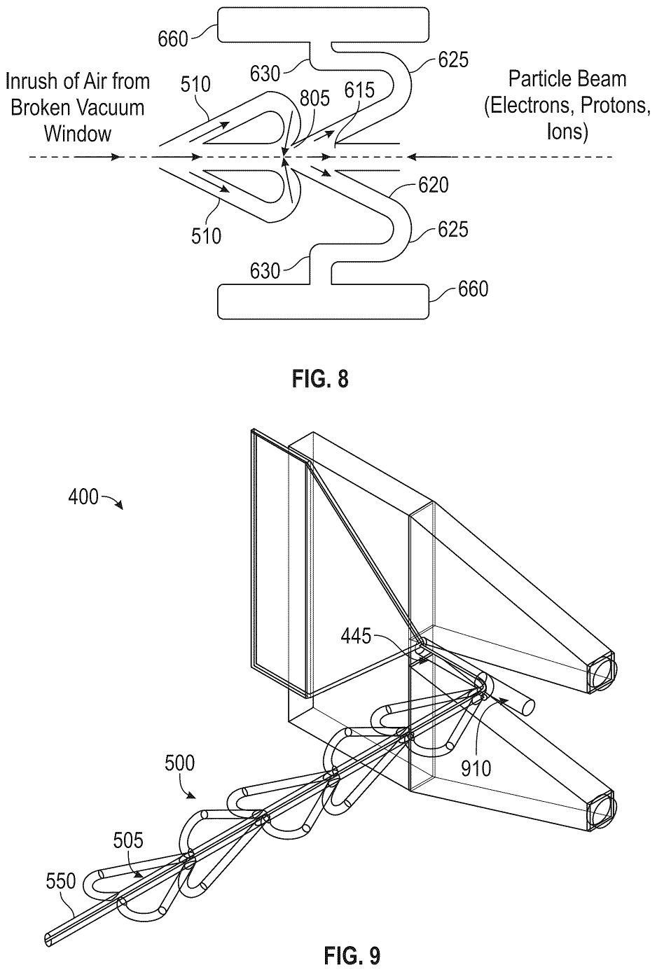

FIG. 9 illustrates the incorporation of a tesla valve with a scan horn and scan horn protector assembly 400. As illustrated, the beam 550 can be directed down the conduit 505 and into the beam pipe 445. The system can be fitted with a magnet assembly to direct the beam 550 through the angle formed between the conduit 505 and beam pipe 445. The system can further include a solid debris catcher 910, for catching loose debris in the event of a vacuum breach. It should be appreciated that aspects of the embodiments illustrated in FIG. 5-8 could equivalently be used in connection with the scan horn protection assembly 400.

Based on the foregoing, it can be appreciated that a number of example embodiments, preferred and alternative, are disclosed herein. In an embodiment, an apparatus, comprises a main line conduit and at least one recirculating side chamber comprising: a side chamber conduit, an inlet to the side chamber conduit, a curve in the side chamber conduit, and an outlet connected to the main line conduit. In an embodiment, airflow exiting the outlet intersects airflow in the main line conduit. In an embodiment, the at least one recirculating side chamber comprises a plurality of recirculating side chambers arranged in line along the main line conduit. In an embodiment, the plurality of recirculating side chambers arranged symmetrically along the main line conduit. In an embodiment, the plurality of recirculating side chambers arranged asymmetrically along the main line conduit. In an embodiment, the main line conduit is configured to transport a particle beam. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

In another embodiment, an apparatus, comprises a main line conduit, and at least one pressure directing side chamber comprising: a side chamber conduit, an inlet connected to a side chamber conduit, a curve in the side chamber conduit, and a manifold connected to the side chamber conduit. In an embodiment, the apparatus further comprises, a pressure vessel attached to the manifold. In an embodiment, the side chamber conduit angles away from the main line conduit. In an embodiment, the at least one pressure directing side chamber comprises a plurality of pressure directing side chambers arranged in line along the main line conduit. In an embodiment, the main line conduit is configured to transport a particle beam. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

In an embodiment, an apparatus, comprises a main line conduit, at least one recirculating side chamber comprising: a side chamber conduit, an inlet to the side chamber conduit, a curve in the side chamber conduit, and an outlet connected to the main line conduit; and at least one pressure directing side chamber comprising: a side chamber conduit, an inlet connected to a side chamber conduit, a curve in the side chamber conduit, and a manifold connected to the side chamber conduit. In an embodiment, the apparatus further comprises a pressure vessel attached to the manifold. In an embodiment, airflow exiting the outlet intersects airflow in the main line conduit. In an embodiment, the apparatus further comprises a plurality of focusing element configured along the main line conduit and configured to modify the waist of a particle beam. In an embodiment, the apparatus further comprises a scan horn protector assembly, wherein the main line conduit connects to a beam port.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An apparatus, comprising:
a main line conduit; and
at least one recirculating side chamber comprising:
a side chamber conduit;
an inlet to the side chamber conduit;
a curve in the side chamber conduit; and
an outlet connected to the main line conduit.

2. The apparatus of claim 1 wherein airflow exiting the outlet intersects airflow in the main line conduit.

3. The apparatus of claim 1 wherein the at least one recirculating side chamber comprises a plurality of recirculating side chambers arranged in line along the main line conduit.

4. The apparatus of claim 3 wherein the plurality of recirculating side chambers arranged symmetrically along the main line conduit.

5. The apparatus of claim 3 wherein the plurality of recirculating side chambers arranged asymmetrically along the main line conduit.

6. The apparatus of claim 1 wherein the main line conduit is configured to transport a particle beam.

7. The apparatus of claim 1 further comprising a plurality of focusing element configured along the main line conduit and configured to modify a waist of a particle beam.

8. The apparatus of claim 1 further comprising:
a scan horn protector assembly, wherein the main line conduit connects to a beam port.

9. An apparatus, comprising:
a main line conduit; and
at least one pressure directing side chamber comprising:
a side chamber conduit;
an inlet connected to a side chamber conduit;
a curve in the side chamber conduit; and
a manifold connected to the side chamber conduit.

10. The apparatus of claim 9 further comprising:
a pressure vessel attached to the manifold.

11. The apparatus of claim 9 wherein the side chamber conduit angles away from the main line conduit.

12. The apparatus of claim 9 wherein the at least one pressure directing side chamber comprises a plurality of pressure directing side chambers arranged in line along the main line conduit.

13. The apparatus of claim 9 wherein the main line conduit is configured to transport a particle beam.

14. The apparatus of claim 9 further comprising a plurality of focusing element configured along the main line conduit and configured to modify a waist of a particle beam.

15. The apparatus of claim 9 further comprising:
a scan horn protector assembly, wherein the main line conduit connects to a beam port.

16. An apparatus, comprising:
a main line conduit;
at least one recirculating side chamber comprising:
a side chamber conduit;
an inlet to the side chamber conduit;
a curve in the side chamber conduit; and
an outlet connected to the main line conduit; and
at least one pressure directing side chamber comprising:
a side chamber conduit;
an inlet connected to a side chamber conduit;
a curve in the side chamber conduit; and
a manifold connected to the side chamber conduit.

17. The apparatus of claim 16 further comprising:
a pressure vessel attached to the manifold.

18. The apparatus of claim 16 wherein airflow exiting the outlet intersects airflow in the main line conduit.

19. The apparatus of claim 16 further comprising a plurality of focusing element configured along the main line conduit and configured to modify a waist of a particle beam.

20. The apparatus of claim 16 further comprising:
a scan horn protector assembly, wherein the main line conduit connects to a beam port.
